(19) United States
(12) Patent Application Publication
(10) Pub. No.: US 2006/0065634 A1
(43) Pub. Date: Mar. 30, 2006

(54) Low temperature susceptor cleaning

(76) Inventor: Jannes Remco Van Den Berg, Emmeloord (NL)

Correspondence Address: KNOBBE MARTENS OLSON & BEAR LLP, 2040 MAIN STREET, FOURTEENTH FLOOR, IRVINE, CA, 92614, US

(21) Appl. No.: 11/228,460

(22) Filed: Sep. 16, 2005

Related U.S. Application Data
(60) Provisional application No. 60/610,983, filed on Sep. 17, 2004.

(51) Int. Cl. C03C 15/00

(52) U.S. Cl. 216/89

(57) ABSTRACT

The surface of a susceptor for supporting a substrate during semiconductor processing is sandblasted and/or treated with a chemical etch in a low temperature cleaning treatment. The cleaning treatment can be performed after grinding the susceptor to the desired dimensions and smoothness during the manufacture of the susceptor. The sandblasting or chemical etch removes contaminants remaining after the grinding. As a result, these contaminants are no longer able to contaminate substrates that are later processed on the susceptor. In addition, a silicon carbide finish film can be deposited on the susceptor to form a surface with a desired roughness and to act as a diffusion barrier to prevent impurities in the susceptor from diffusing out and contaminating substrates supported on the susceptors.

### REFERENCE TO RELATED APPLICATION

This application claims the priority benefit of U.S. Provisional Application No. 60/610,983, filed Sep. 17, 2004, the entire disclosure of which is incorporated herein by reference.

This application is also related to and incorporates by reference in their entireties each of the following: U.S. patent application Ser. No. 11/081,358, filed Mar. 15, 2005; U.S. patent application Ser. No. 10/636,372, filed Aug. 7, 2003; U.S. Pat. No. 6,835,039, issued Dec. 28, 2004; and U.S. Pat. No. 6,582,221, issued Jun. 24, 2003.

### BACKGROUND OF THE INVENTION

1. Field of the Invention

This invention relates generally to semiconductor processing and, more particularly, to cleaning the susceptors that are used to support substrates during processing.

2. Description of the Related Art

Some semiconductor fabrication techniques can involve processing semiconductor substrates, such as wafers, in batches in furnaces. The substrates can be supported on susceptors during process. Such susceptors are typically accommodated in a wafer boat that can be loaded into and unloaded out of a furnace. Susceptors used in high temperature processing, e.g., processing at temperatures of 1000° C. or more, are often made of free-standing chemical vapor deposition (CVD) silicon carbide because this material is resistant to high temperatures and has a very high purity.

A silicon carbide susceptor can be made using a sacrificial substrate as a mold. The sacrificial substrate has the desired shape for the susceptor. To form the susceptor, a thick silicon carbide film is deposited on the substrate by chemical vapor deposition. The sacrificial substrate is later removed, thereby leaving a silicon carbide object with roughly the desired shape for a susceptor. Graphite is commonly used as the sacrificial substrate material, since it can be easily removed by oxidation.

After depositing the thick silicon carbide film, the surface of the silicon carbide film can be subjected to a mechanical treatment to achieve the desired surface smoothness and dimensions for the susceptor. Such a mechanical treatment typically involves grinding the silicon carbide surface. Grinding, however, tends to induce micro-cracks in the susceptor. These microcraps can trap contaminants, including liquids and abrasive materials that are used during grinding. During processing, the contaminants can come into contact with and undesirably contaminate substrates that are processed on the susceptor.

Accordingly, there is a need for methods of minimizing contamination of susceptors.

### SUMMARY OF THE INVENTION

According to one aspect of the invention, a method of manufacturing a susceptor is provided. The method comprises chemical vapor depositing a silicon carbide material. The silicon carbide material is subjected to a mechanical, abrasive treatment. The treated silicon carbide material is subsequently subjected to a low temperature cleaning.

According to another aspect of the invention, a method of manufacturing a susceptor is provided. The method comprises forming a silicon carbide susceptor. Surfaces of the susceptor are planarized by abrasion. A layer of silicon carbide is removed from at least a portion of the susceptor after planarizing. A thickness of the removed layer of silicon carbide is about 0.6 μm or more.

According to yet another aspect of the invention, a method is provided for cleaning a susceptor for supporting semiconductor substrates. The method comprises providing a semiconductor substrate susceptor. The susceptor is subjected to a cleaning treatment at a temperature of about 500° C. or less.

### BRIEF DESCRIPTION OF THE DRAWINGS

The invention will be better understood from the Detailed Description of the Preferred Embodiments and from the appended drawings, which are meant to illustrate and not to limit certain aspects of the invention, and wherein:

FIG. 1 shows the steps of manufacturing a susceptor, in accordance with preferred embodiments of the invention;

FIG. 2 is a schematic, top view of an exemplary susceptor, in accordance with preferred embodiments of the invention; and

FIG. 3 is a schematic, cross-sectional side view of a furnace provided with a wafer boat and susceptors, in accordance with preferred embodiments of the invention.

### DETAILED DESCRIPTION OF THE PREFERRED EMBODIMENTS

Standard cleaning techniques have been found to be ineffective at removing contaminants from cracks in susceptors. One standard cleaning technique is a high temperature cleaning in an HCl ambient. Rather than being removed, however, contaminants have been found to diffuse into silicon carbide susceptors, due in part to the high temperatures used in the cleaning. Subsequently, when the susceptor is again subjected to high temperatures, e.g., during high temperature processing of a batch of substrates in a furnace, the contaminants can diffuse out and undesirably contaminate processed substrates.

Preferred embodiments of the invention provide a method for cleaning a susceptor while minimizing contaminant diffusion into the susceptor. Preferably, the method includes cleaning performed at a low temperature, which is sufficiently low to prevent significant diffusion of impurities into the susceptor. In addition, the susceptor is preferably subjected to sandblasting and/or chemical etching, which can open and/or remove micro-cracks. Advantageously, contaminants, e.g., metal contaminants (left over from, e.g., grinding the susceptor), which are trapped in the micro-cracks, can be released and a source of contaminants during substrate processing is thereby removed.

Where the low temperature cleaning comprises sandblasting, the sandblasting is preferably performed under ultra-pure conditions, which can advantageously prevent the introduction of metallic contamination. As part of the ultra-pure conditions, a clean grit is preferably used. In some embodiments, the clean grit is pure silicon carbide grit. In other embodiments, ice (frozen water) grit can be used or any other suitable grit material that does not contain metals and/or does not reintroduce metals. Examples of other suitable grit materials include diamond, tungsten carbide, etc. In addition to the clean grit, the ultra-pure conditions preferably also entail using a very pure and inert gas as the driving gas for the grit blasting. Preferably, process grade compressed nitrogen is used as the driving gas. Also, materials that are in contact with the grit, such as nozzles, conduits, etc. are preferably made of ceramic materials that do not cause metal contamination.

Advantageously, in addition to cleaning a susceptor, the sandblasting induces a particular surface roughness. Preferably, the sandblasting results in a surface roughness with a Ra of about 0.6 μm or more, more preferably, a Ra of about 1.0 μm or more and, most preferably, a Ra of about 2.0 μm or more. It will be appreciated that forming a surface having these Ra values provides advantages for minimizing crystallographic slip during substrate processing, as discussed below.

In other embodiments, the low temperature cleaning treatment comprises a wet-etch of the susceptor. To remove sufficient material to adequately clean the susceptor, the thickness of material removed by the wet-etch is preferably about 0.6 μm or more, more preferably, about 1.0 μm or more and, most preferably, about 2.0 μm or more.

In some embodiments, both sandblasting and a wet etch can be used in the low temperature cleaning. In addition, post cleaning processes can optionally be performed to form a surface with desired properties. For example, a film can be deposited on the susceptor to form a surface with the desired roughness. In some cases, a diffusion barrier can be deposited to prevent any impurities inside a susceptor from diffusing out and contaminating a substrate.

Advantageously, the preferred embodiments provide susceptors with a low level of contamination. The removal of material by, e.g., sandblasting or chemical etching, can open up microcracks to release trapped contaminants. In addition, cleaning at low temperatures can minimize the diffusion of contaminants into the susceptor, to help ensure that they are removed, rather than simply redistributed within the material. Also, by forming a surface with a particular roughness, the susceptor can be formed with a surface which minimizes crystallographic slip. Prevention of contaminant diffusion from the susceptor into a substrate and a desired surface roughness of the susceptor can also be achieved by depositing a finish film, which forms the upper surface of a susceptor, having the desired diffusion barrier and/or surface roughness properties. The finish film can advantageously increase process latitude for preceding cleaning treatments, since the risk of contaminant diffusion is reduced and since concerns of forming a surface with less than desired surface roughness is also reduced. Thus, higher quality process results can be achieved using susceptors formed according to the preferred embodiments.

Reference will now be made to the Figures, wherein like numerals refer to like parts throughout.

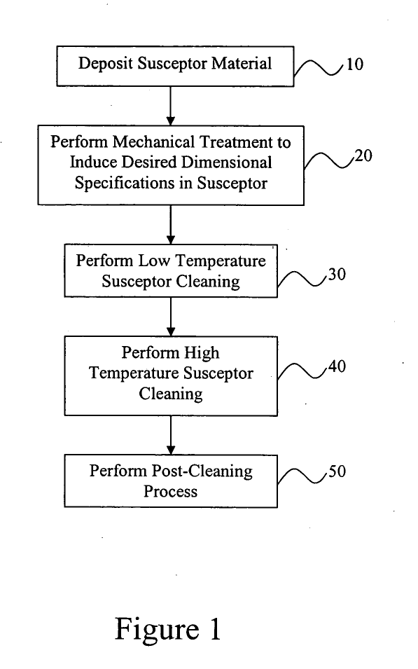

With reference to FIG. 1, an exemplary sequence of steps for forming a susceptor is schematically represented. First, as indicated by reference numeral 10, silicon carbide (SiC) for forming the susceptor is deposited. Preferably, the SiC is deposited by chemical vapor deposition (CVD) on a sacrificial support material to a thickness that is sufficient to allow removal of the sacrificial material (e.g., graphite), in a process analogous to a “lost wax” method of transferring molds. Such a method is disclosed in U.S. Pat. No. 4,978,567, issued Dec. 18, 1990 to Miller, the entire disclosure of which is incorporated herein by reference.

Next, as indicated by reference numeral 20, the CVD SiC layer undergoes a mechanical treatment to form the CVD SiC material to the precise dimensional specifications desired for the susceptor and to remove any protrusions that might be present on the susceptor surface. The mechanical treatment can include, e.g., an abrasive process in which the SiC material is ground into the desired shape and dimensions. The sacrificial material can then be removed, e.g., by machining and/or burning off graphite, where the sacrificial material is graphite.

As indicated by reference numeral 30, after the abrasive mechanical treatment 20, but before any high temperature treatment, the CVD SiC is preferably subjected to a low temperature cleaning treatment. The cleaning treatment 30 is such that micro-cracks in the surface are preferably opened. The temperature at which the cleaning treatment is performed is preferably low enough to prevent significant diffusion of impurities. Preferably, the cleaning temperature is below about 500° C. and, more preferably, the cleaning temperature is below about 250° C. and, even more preferably, the cleaning temperature is below about 100° C. In addition, the low temperature cleaning is preferably performed in a substantially metal free atmosphere to prevent contamination of the susceptor by metals from the atmosphere.

In preferred embodiments of the invention, the cleaning treatment includes sandblasting. It will be appreciated that sandblasting includes the use of any particular matter, or grit, to wear away material on a susceptor. In some preferred embodiments, the sandblasting is performed to an extent and with a grit that induces a surface roughness with an Ra value equal to about 0.6 μm or more, more preferably, an Ra value equal to about 1.0 μm or more and, most preferably, an Ra value equal to about 2.0 μm or more, as measured with a surface profilometer commercially available from Mitutoyo Corporation of Japan. Advantageously, surface roughness in these ranges allow semiconductor wafers to be processed at high temperatures with minimal crystallographic slip, as discussed in U.S. patent application Ser. No. 11/081,358, filed Mar. 15, 2005, entitled SUSCEPTOR WITH SURFACE ROUGHNESS FOR HIGH TEMPERATURE WAFER PROCESSING, the entire disclosure of which is incorporated by reference herein.

It has been found that wafers processed on susceptors with these roughness values have exceptionally low levels of crystallographic slip. Contrary to expectations that slip decreases with increasing susceptor smoothness, it has been found that the slip can increase with smoothness. Without being limited by theory, it is believed that non-uniformities in flatness can result in non-uniformities in heat transfer, causing the temperature across a substrate to vary from location to location, thereby causing slip. By using a susceptor plate with a surface roughness that is equal to or larger than a certain minimal value, it has been found that heat transfer from a substrate to a susceptor plate can be made more uniform. A rough surface reduces the amount of contact at the points where direct susceptor to substrate contact would occur, thereby minimizing heat transfer at those points and bringing the heat transfer at those points closer to the level of heat transfer at other points across the substrate. Thus, advantageously, temperature non-uniformities are reduced and the occurrence of crystallographic slip is minimized.

In other embodiments, the cleaning treatment can be a chemical etch treatment that removes part of the CVD SiC material. Preferably, the etch removes a top layer of the CVD SiC material from at least a portion of the susceptor, and, more preferably, uniformly over the surface of the susceptor. The layer of material removed preferably has a thickness of about 0.6 μm or more, more preferably, about 1.0 μm or more, and, most preferably, about 2.0 μm or more. Etching of this thickness of material has been found to advantageously allow for adequate cleaning of the susceptor, by sufficiently opening microcracks and removing of contaminants, while not weakening the susceptor or significantly altering susceptor dimensions. Exemplary etch processes are wet chemical etching using aqua regia or electrochemical etching using sodium hydroxide or potassium hydroxide at about 50-60° C.

After the cleaning treatment 30, and before the susceptor is used for processing a substrate, a high temperature cleaning step, as indicated by reference numeral 40, can be performed at a temperature substantially higher than the temperature for the low temperature cleaning. Preferably, the high temperature cleaning is performed with a chlorine-containing ambient, e.g., an HCL ambient, at a temperature of about 400° C. or higher, more preferably, about 500° C. or higher.

As indicated by reference numeral 50, the susceptor can be subjected to a post cleaning process to, e.g., form a surface with particular desired properties. For example, it will be appreciated that chemical etching has a tendency to smooth the surface of the susceptor and, so, might result in a surface that is smoother than desirable. Therefore, in some embodiments of the invention, a low temperature cleaning, comprising chemical etching, is followed by a film deposition process to form a surface finish so that the susceptor has the desired surface roughness. The film preferably comprises a CVD SiC film. Preferably, the film has a thickness of at least about 1 μm thick and at most about 10 μm thick. Advantageously, a deposited film in this thickness range increases the surface roughness of the susceptor but avoids the risk of creating protrusions on the surface. Consequently, no mechanical treatment to remove protrusions from the surface is needed after this film deposition. A mechanical treatment is preferably avoided as it has a high risk of reintroducing contaminants to the susceptor. It will be appreciated that the film deposition process can be performed after step 40, or after step 30 and omitting step 40. For example, a manufacturing process for forming a susceptor can be concluded by the ultraclean CVD SiC deposition process as the last step.

Advantageously, CVD SiC films are good diffusion barriers. As a result, any eventual impurities which may still be present after the low temperature cleaning can be confined to the interior of the susceptor and will not diffuse out to contaminate a wafer.

It will be appreciated that a CVD film, e.g., formed of SiC, of about 1-10 μm thick can also be deposited after a low temperature clean that comprises sandblasting only. In addition, in some embodiments, the CVD SiC surface finish film is a carbon rich CVD SiC film which is subjected to an oxidizing treatment to remove any excess of carbon, thereby creating a porous film.

It will also be appreciated that the low temperature cleaning can comprise both sandblasting and a low temperature chemical etching. For example, sandblasting followed by the low temperature chemical etching can be performed. In such a case, a post-cleaning surface finish film that increases the surface roughness, as described above, is preferably deposited if the surface roughness after the chemical etching is smoother than desired. In other embodiments, chemical etching can be followed by sandblasting, which can have advantages for forming a surface with the desired surface roughness in cases where the chemical etching has left a surface which is too smooth. The thickness of material removed is preferably more than about 0.6 μm, more preferably, more than about 1.0 μm and, most preferably, more than about 2.0 μm and the Ra of the surface is preferably about 0.6 μm or more, more preferably, about 1.0 μm or more and, most preferably, about 2.0 μm or more.

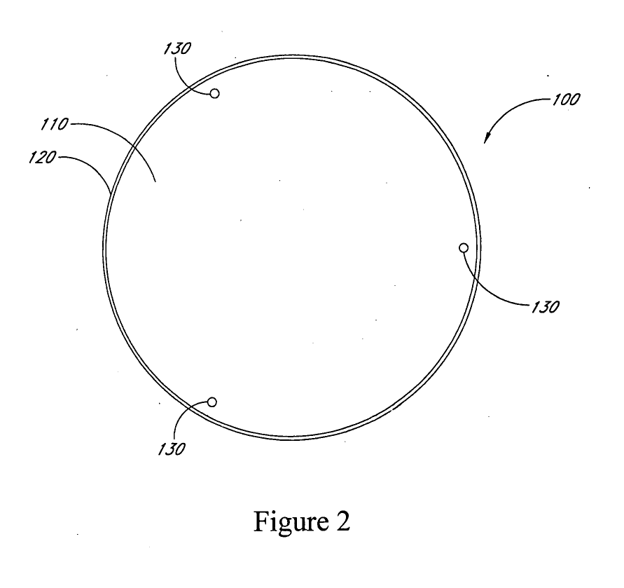

With reference to FIG. 2, an exemplary susceptor 100 formed in accordance with the preferred embodiments is shown. The susceptor plate 100 preferably has a diameter slightly larger than the diameter of the wafer that the susceptor plate 100 will support. It will be appreciated that, while circular in the illustrated embodiment, the susceptor plate 100 can be any shape. The support surface 110 for supporting a wafer thereon is preferably substantially flat. At the circumference the susceptor plate 100 can optionally be provided with a raised shoulder or edge 120. During heat-up, the raised edge 120 shields the wafer edge against excessive heat radiation during heat-up, avoiding overheating of the wafer edge. During cool-down, the raised edge 120 shields the wafer from cooling too rapidly. Furthermore, the raised edge 120 prevents the wafer from moving horizontally during transport of the susceptor plate 100 with a wafer thereon. The susceptor plate 100 can also optionally be provided with three or more through holes 130 to facilitate automatic loading. The susceptor plate 100 is preferably sized to extend across and support substantially an entire bottom surface of a substrate, except for, e.g., parts of the substrate overlying the holes 130.

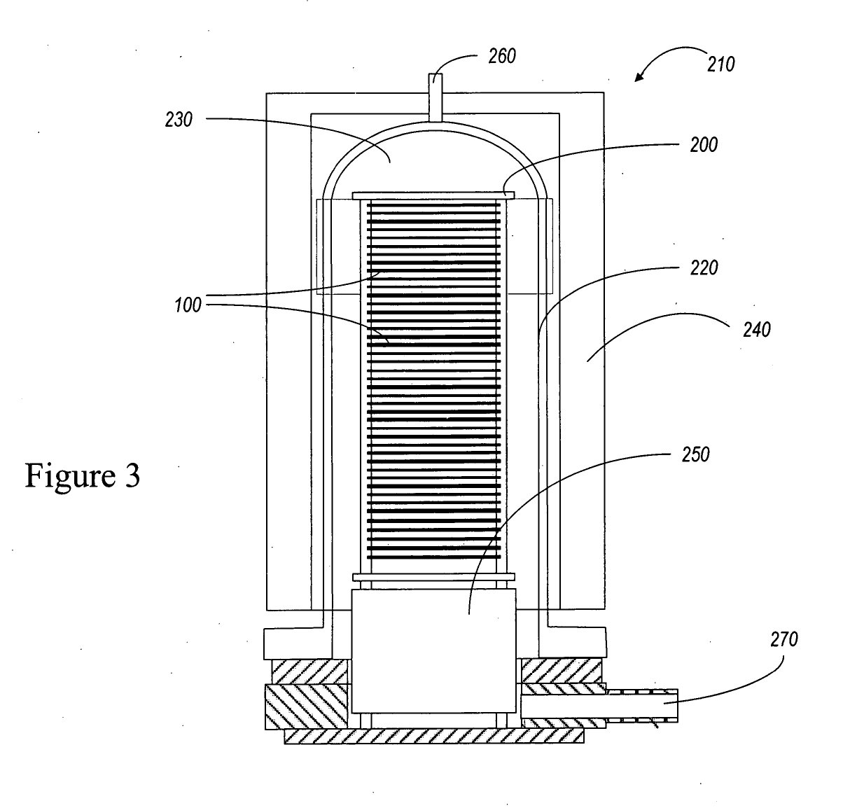

While the susceptor 100 can be used to support a substrate in other processing environments or chambers, it will be appreciated that the susceptor plate 100 can advantageously be accommodated in a susceptor holder 200, e.g., a wafer boat, in a batch reactor 210 during substrate processing, as shown schematically in FIG. 3. The reactor 210 comprises a process tube 220 which defines a process chamber 230. The process tube 220 and the wafer boat 200 are preferably formed of quartz. A heater 240 surrounds the process tube 220. A pedestal 250 supports the wafer boat 200. The illustrated reactor 210 is a vertical furnace in which process gases can be fed into the process chamber 230 via an inlet 260 at the top of the chamber 230. The gases can be evacuated out of the chamber 230 from an exhaust 270 at the bottom of the chamber 230. It will be appreciated that the exhaust 270 and inlet 260 can be otherwise configured. For example, the inlet can be located at the bottom of the chamber, or can comprise multiple vertically spaced holes along the height of the boat. The reaction chamber 230 accommodates the wafer boat 200, which holds a stack of vertically spaced susceptors 100 upon which wafers are supported. Preferably, the boat 200 can hold 50 or more wafers. A suitable, exemplary batch reactor is commercially available under the trade name A400™ or A412™ from ASM International, N.V. of the Netherlands. The skilled artisan will appreciate, however, that the principles and advantages disclosed herein will have application to other types of reactors, including other batch reactors. The reactors are preferably configured to treat substrates at about 1000° C. or greater.

While described with reference to susceptors formed of a SiC material, it will be appreciated that the susceptors may be formed of other materials which may be susceptible to contamination in micro-cracks and for which sandblasting and/or wet etching is suitable. For example, the preferred embodiments can be applied to clean susceptors formed of graphite, Al₂O₃, WC and TiN and other ceramic and refractory materials. In addition, while processing at high temperatures, e.g., at 1000° C. or more, is particularly problematic from the standpoint of releasing contaminants from the susceptors to a wafer, susceptors formed as described herein can be used in processing at any temperature suitable for semiconductor processing, including over 1000° C. Moreover, while illustrated for use in a furnace with a wafer boat, the susceptor can be used in other processing environments or chambers. In addition, it will be appreciated that the cleaning treatment may be applied to clean the entire surface of the susceptor or only the surface of the susceptor upon which a wafer will rest. Also, while advantageously applied after an abrasive mechanical treatment, it will be appreciated that the cleaning treatment can be applied at various other times, during and after manufacture of the susceptor, to clean the susceptor. For example, the cleaning treatments and post-cleaning processing described herein can be applied to clean a susceptor, e.g., a susceptor previously used in semiconductor processing, which was not manufactured using the process illustrated in FIG. 1.

Accordingly, it will be appreciated by those skilled in the art that various other omissions, additions and modifications may be made to the methods and structures described above without departing from the scope of the invention. All such modifications and changes are intended to fall within the scope of the invention, as defined by the appended claims.

I claim:

1. A method of manufacturing a susceptor, comprising:
chemical vapor depositing a silicon carbide material;
subjecting the deposited silicon carbide material to a mechanical, abrasive treatment; and
subsequently subjecting the treated silicon carbide material to a low temperature cleaning.

2. The method of claim 1, wherein the low temperature cleaning is performed at a temperature below about 500° C.

3. The method of claim 2, wherein the low temperature is below about 100° C.

4. The method of claim 1, wherein the low temperature cleaning comprises sandblasting.

5. The method of claim 1, wherein sandblasting comprises wearing away silicon carbide material with one or more materials chosen from the group consisting of clean silicon carbide grit, frozen water, diamond and tungsten carbide.

6. The method of claim 4, wherein sandblasting forms a susceptor surface having a surface roughness with an Ra value of about 0.6 μm or more.

7. The method of claim 6, wherein the Ra value is about 1.0 μm or more.

8. The method of claim 7, wherein the Ra value is about 2.0 μm or more.

9. The method of claim 4, wherein sandblasting comprises driving grit materials with a substantially pure inert gas.

10. The method of claim 9, wherein the gas is process grade compressed nitrogen gas.

11. The method of claim 4, wherein subjecting the treated silicon carbide material to the low temperature cleaning further comprises performing a chemical etch.

12. The method of claim 1, wherein performing a low temperature cleaning comprises performing a chemical etch.

13. The method of claim 12, wherein the low temperature cleaning is performed at about 50-60° C. and comprises an electrochemical etching process using sodium hydroxide or potassium hydroxide.

14. The method of claim 12, wherein the low temperature cleaning comprises performing a wet chemical etch using aqua regia.

15. The method of claim 12, wherein the low temperature cleaning removes a layer of material having a thickness of about 0.6 μm or more.

16. The method of claim 15, wherein the thickness of removed material is about 1.0 μm or more.

17. The method of claim 16, wherein the thickness of removed material is about 2.0 μm or more.

18. The method of claim 1, further comprising exposing the susceptor to a chlorine-containing ambient after the low temperature cleaning.

19. The method of claim 18, wherein exposing the susceptor to a chlorine-containing ambient comprises exposing the susceptor to a temperature substantially higher than a temperature for the low temperature cleaning.

20. The method of claim 19, wherein exposing the susceptor to a chlorine-containing ambient comprises exposing the susceptor to a temperature of about 400° C. or higher.

21. The method of claim 19, wherein exposing the susceptor to a chlorine-containing ambient comprises exposing the susceptor to a temperature of about 500° C. or higher.

22. The method of claim 1, wherein the low temperature cleaning is performed in a substantially metal-free atmosphere.

23. The method of claim 1, wherein the susceptor is a plate and, after subjecting the deposited silicon carbide material to the mechanical, abrasive treatment, an upper surface of the susceptor is sized to extend across and support an entire bottom surface of a substrate, upon retention of the substrate on the susceptor.

24. The method of claim 1, wherein the susceptor is configured for use in a wafer boat for accommodating a plurality of wafers on susceptors.

25. The method of claim 1, wherein chemical vapor depositing the silicon carbide material comprises depositing silicon carbide on a sacrificial support material and subsequently removing the sacrificial support material.

26. The method of claim 25, wherein the sacrificial support material is graphite.

27. The method of claim 26, wherein removing the sacrificial support material comprises burning off the sacrificial material.

28. A method of manufacturing a susceptor, comprising:
forming a silicon carbide susceptor;
planarizing surfaces of the susceptor by abrasion; and
removing a layer of silicon carbide from at least a portion of the susceptor after planarizing, wherein a thickness of the removed layer of silicon carbide is about 0.6 μm or more.

29. The method of claim 28, wherein removing is performed at about 500° C. or less.

30. The method of claim 29, wherein removing is performed at about 250° C. or less.

31. The method of claim 28, wherein removing comprises a wet-etch.

32. The method of claim 31, wherein removing further comprises sandblasting or bombarding the susceptor with grit.

33. The method of claim 32, wherein removing roughens susceptor surfaces.

34. The method of claim 28, wherein removing removes contaminants from cracks in the susceptor.

35. A method of cleaning a susceptor for supporting semiconductor substrates, comprising:
providing a semiconductor substrate susceptor;
subjecting the susceptor to a cleaning treatment at a temperature of about 500° C. or less.

36. The method of claim 35, wherein subjecting the susceptor to the cleaning treatment comprises performing one or more processes chosen from the group consisting of sandblasting and chemical etching.

37. The method of claim 36, wherein further comprising depositing a surface finish film on the susceptor after subjecting the susceptor to the cleaning treatment.

38. The method of claim 37, wherein depositing the surface finish film comprises chemical vapor depositing a silicon carbide film.

39. The method of claim 38, wherein the silicon carbide film has a thickness of about 1-10 μm.

40. The method of claim 38, wherein the silicon carbide film has a surface roughness with an Ra value of about 1.0 μm or more.

41. The method of claim 38, wherein the silicon carbide film is a carbon rich SiC film.

42. The method of claim 41, further comprising removing carbon from the carbon rich SiC film.

43. The method of claim 42, wherein removing carbon comprises oxidizing the carbon rich SiC film.
